(19) United States
(12) Patent Application Publication
(10) Pub. No.: US 2009/0284349 A1
(43) Pub. Date: Nov. 19, 2009

(54) Method for Tamperproof Identification of Individual Electronic Sub-Assemblies

(75) Inventor: Otmar Wanierke, Munchen (DE)

Correspondence Address: MARSHALL, GERSTEIN & BORUN LLP, 233 SOUTH WACKER DRIVE, 6300 SEARS TOWER, CHICAGO, IL, 60606-6357, US

(73) Assignee: Rohde & Schwarz GmbH & Co. KG, Munchen (DE)

(21) Appl. No.: 11/917,325

(22) PCT Filed: Jun. 29, 2006
(86) PCT No.: PCT/EP06/06321

§ 371 Date: Mar. 3, 2008

(30) Foreign Application Priority Data
Jul. 5, 2005 (DE) 10 2005 031 378.7

(51) Int. Cl. H04Q 5/22

(52) U.S. Cl. 340/10.1

(57) ABSTRACT

A method for tamperproof identification of individual electronic sub-assemblies determines the state changes of specific memory cells of the memory resulting from a specific interruption of one or more auxiliary functions of a memory of an individual electronic sub-assembly and compares them with respect to identity with predetermined memory-characteristic reference state changes of specific memory cells of the memory resulting from the specific interruption of the auxiliary function of the memory of the electronic sub-assembly.

The invention relates to a method for tamperproof identification of individual electronic sub-assemblies.

In addition to type-specific identification of electronic sub-assemblies there are more and more applications in which individual identification of electronic sub-assemblies is desired. The application spectrum for individual identification of electronic sub-assemblies is diverse. On the one hand, it serves to identify an electronic sub-assembly present in a system or with a user and hence to uncover a theft or exchange of an electronic sub-assembly. With individual identification of an electronic sub-assembly, the software producer can, on the other hand, check the software which is licensed for a specific electronic sub-assembly with respect to correct usage. Analogously, with the individual identification of an electronic sub-assembly, a provider of an electronic service can check authorized use of an electronic service which is being used via a specific electronic sub-assembly and also determine and invoice the occurring usage charges correctly.

Identification of the individual electronic sub-assembly is achieved via identification data which are stored either in special log components—for example an Ethernet-MAC-address log or hard disc controller identification log—or in write-protected memory regions of standard memories.

In DE 195 23 654 A1, the individual identification of a transponder is stored for example in an identification source produced as a log memory. Simply by writing to the memory cells of the identification source with a changed identification or by exchanging the identification source for an identical identification source in which a changed identification is stored, the individual identification of the electronic sub-assembly can be manipulated comparatively easily. A tamperproof identification of the individual electronic sub-assembly is hence not ensured.

The object therefore underlying the invention is to produce a method for identification of individual electronic sub-assemblies in which the identification of the individual electronic sub-assembly is maintained in a tamperproof manner over the lifespan of the individual electronic sub-assembly.

The object of the invention is achieved by an individual electronic sub-assembly with a tamperproof identification according to claim 1 and by a method for tamperproof identification of individual electronic sub-assemblies according to claim 4. Advantageous developments of the invention are cited in the dependent claims.

For unequivocal identification of an individual electronic sub-assembly, the physical effect is used that the memory cells of a dynamic volatile semiconductor memory—DRAM memory component—change their memory contents after interruption of an auxiliary function of the memory—for example specific short-term switching-off of the supply voltage, specific short-term removal of the clock signal, specific short-term discontinuation of the refresh cycles. These changes in the memory contents of the individual memory cells of the semiconductor memory as a result of interruption of an auxiliary function of the memory are dependent upon the production conditions which prevail respectively during manufacture of the respective memory—for example doping level of the individual memory cells of the memory in the respective manufacturing batch—and hence have a specific uniqueness which can be used according to the invention as an individual feature of the memory and hence of the associated electronic sub-assembly.

This physical effect is exploited according to the invention in that specific pre-established memory cells of a memory situated on the electronic sub-assembly are pre-allocated during normal operation of the memory with specific pre-established memory contents—bit patterns. After a specifically produced interruption of an auxiliary function of the memory, each of the pre-established memory cells of the memory changes its memory contents according to a specific statistical probability over time. If the interruption is temporally limited, then a part of the memory cells has a changed memory content because of the statistics of this physical effect, whereas the other part of the memory cells still has its previous memory content. After re-establishment of normal operation of the memory, via a comparison of the memory contents of the pre-established memory cells of the memory between the two times before and after the specific interruption of the auxiliary function of the memory, those memory cells which have a state change in the memory contents are determined.

It can be established in general that not only the holding time of each individual memory cell of the semiconductor memory is subject to statistical variations but also the holding times of the individual memory cells of the semiconductor memory are subjected to a statistical regularity relative to each other which is however significantly less pronounced in relation to the statistics of the holding time of each individual memory cell of the semiconductor memory and consequently is used for the method according to the invention for tamperproof identification of individual electronic sub-assemblies.

Because of the statistical behavior of this physical effect, determination of the memory cells of the memory which have a state change resulting from a specifically produced interruption of an auxiliary function of the memory is implemented repeatedly. The smaller statistical scatter of the state changes of a plurality of individual memory cells amongst each other relative to the statistical scatter of the state changes of respectively one individual memory cell causes, after multiple repetition of the determination of state changes in the pre-established memory cells, a frequency distribution of the state changes in the individual memory cells with pronounced maxima and minima. In that a state change of the respective memory cell is assigned to the maxima in the frequency distribution and no state change is assigned to the minima of the frequency distribution, a characteristic feature for the individual memory and hence for the individual electronic sub-assembly is hence produced, said feature being used for the method according to the invention for tamperproof identification of an individual electronic sub-assembly.

The statistics in the state changes of the pre-established memory cells of the semiconductor memory require determination of the state changes of the pre-established memory cells to be implemented again and again in the sense of the above-described procedure. In order to identify correctly an individual electronic sub-assembly, the state changes, which are determined for the first time according to the above-described procedure, of the pre-established memory cells of the semiconductor memory are stored as reference state changes and serve as a comparison for the state changes, which are determined at a later time according to the above-described procedure, of the pre-established memory cells.

An individual electronic sub-assembly is identified according to the invention if the state changes, which are determined at a later time according to the above-described procedure, of the pre-established memory cells of the semiconductor memory are smaller in their number than an upper boundary value and at the same time correspond at least in a partial quantity to the firstly determined state changes which are stored as reference state changes in a memory region of the memory. It is ensured in this way that the state changes which are determined at a later time are within the statistical scatter of the firstly determined reference state changes and hence the stored reference state changes have not been manipulated in the meantime and represent the identification which characterizes the individual electronic sub-assembly. Maintaining the first condition of a smaller number relative to an upper boundary value of determined state changes in the pre-established memory cells of the semiconductor memory guarantees the setting of an interruption time of the auxiliary function of the memory during which no complete or approximately complete state change of all the pre-established memory cells of the semiconductor memory is effected and hence a number of state changes which is meaningful for unequivocal characterization of an individual electronic sub-assembly is present.

An individual electronic sub-assembly is not identified according to the invention if the state changes, which are determined at a later time according to the above-described procedure, of the pre-established memory cells of the semiconductor memory have fallen below a lower boundary value in their number and there are no or only a few correspondences with the firstly determined state changes which are stored as reference state changes in a memory region of the memory. If no or only a low correspondence occurs between the firstly determined reference state changes and the state changes determined at a later time, then it must be assumed that the stored reference state changes have been manipulated in the meantime and hence no tamperproof identification of the individual electronic sub-assembly is present. If the number of state changes, which are determined at a later time, of the pre-established memory cells of the semiconductor memory falls below the pre-established lower boundary value, then the set interruption duration of one of the auxiliary functions of the memory has been chosen to be too short and the hence determined state changes are not usable because of their statistical character for a reliable characterization of the individual electronic sub-assembly.

In the case where the number of state changes, which are determined at a later time, of the pre-established memory cells of the semiconductor memory exceeds the pre-established upper boundary value, the state changes, which result from an interruption of an auxiliary function of the memory, of the pre-established memory cells are re-determined with a shorter interruption time. Analogously, in the case where the number of state changes, which are determined at a later time, of the pre-established memory cells of the semi-conductor memory falls below the established lower boundary value, the state changes, which result from an interruption of an auxiliary function of the memory, of the pre-established memory cells with a longer interruption time are re-determined.

According to the invention, the firstly determined reference state changes of the pre-established memory cells of the semiconductor memory can also be stored in a coded form. For identification of the individual electronic sub-assembly, the state changes, which are determined at a later time, of the pre-established memory cells are accordingly encoded with the same code and are compared with respect to identity with the stored coded reference state changes. The coding can be effected preferably via a hash function in which the data format of the coded state changes or coded reference state changes is reduced relative to the data format of the uncoded state changes or uncoded reference state changes. Furthermore, a further identifying feature of the individual electronic sub-assembly—for example the serial number of the electronic sub-assembly—can in addition be integrated into the coding. In this way, an identification feature which precisely characterizes the individuality of the respective electronic sub-assembly is made available.

In addition to the advantage of the tamperproofness, the method according to the invention for identification of individual electronic sub-assemblies can be achieved without additional hardware components since the hardware-related prerequisites which are demanded for determination of the state changes of the pre-established memory cells of a semiconductor memory are fulfilled in the case of each digital electronic sub-assembly. Implementation of the method according to the invention can be achieved in a comparatively simple manner with a firmware implemented on the electronic sub-assembly.

An embodiment of the method according to the invention for tamperproof identification of individual electronic sub-assemblies is explained subsequently in more detail with consideration of the drawings. There are shown in the drawings:

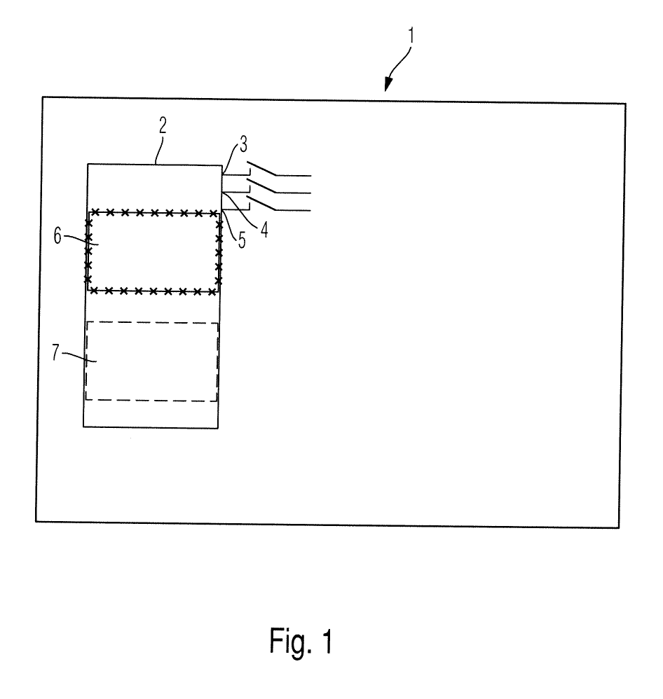

FIG. 1 a block diagram of an individual electronic sub-assembly with a tamperproof identification,

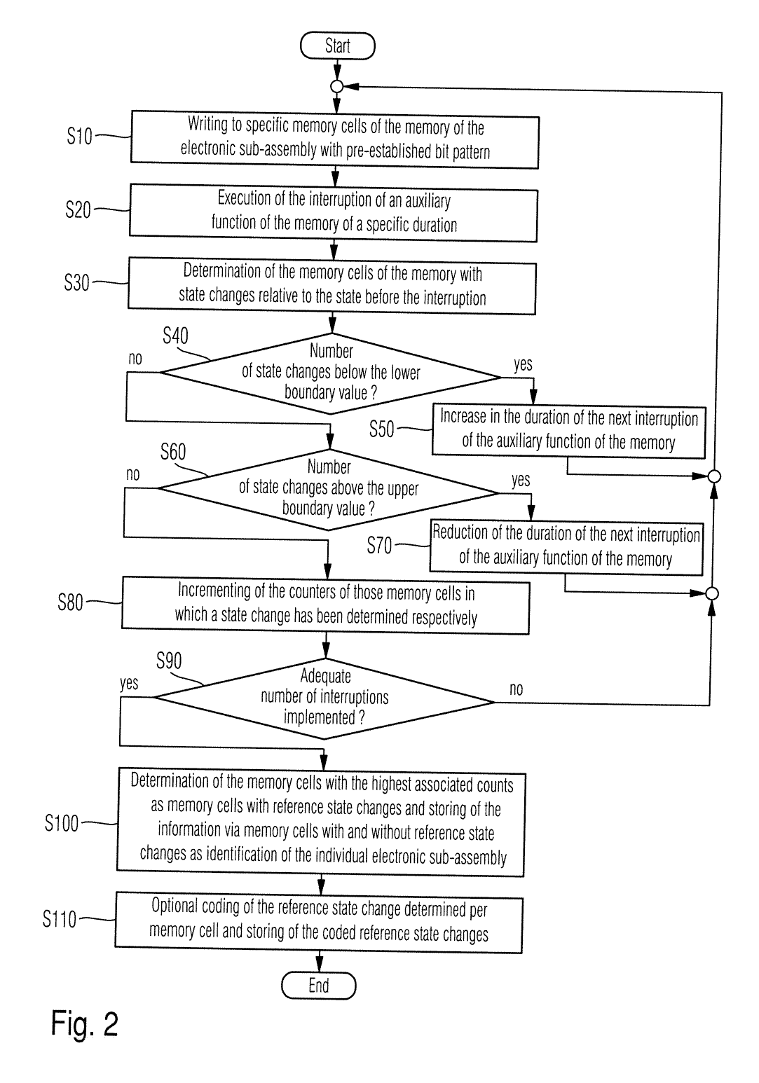

FIG. 2 a flow diagram of the initialization phase of the method according to the invention for tamperproof identification of individual electronic sub-assemblies and

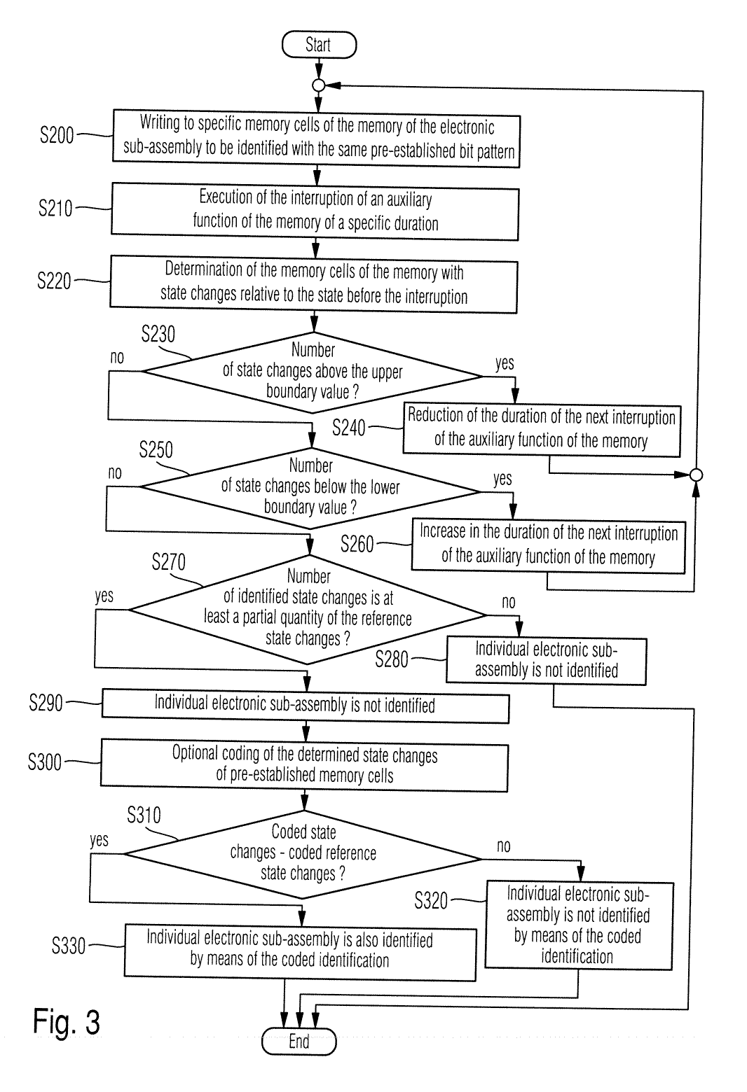

FIG. 3 a flow diagram of the test phase of the method according to the invention for tamperproof identification of individual electronic sub-assemblies.

An individual electronic sub-assembly 1 is described with reference to FIG. 1, having the essential components for the method according to the invention for tamperproof identification of individual electronic sub-assemblies.

Included in the features, which are essential to the invention, of the individual electronic sub-assembly 1 there is a dynamic volatile semiconductor memory—DRAM component—2, which has a connection 3 for a supply voltage, a connection 4 for a clock signal and a connection 5 for refreshing the volatile semiconductor memory. The connections 3, 4 and 5—indicated in FIG. 1 by corresponding switches—are produced to be switchable.

In the semiconductor memory 2, a specific first memory region 6 with a specific pre-established number of memory cells is reserved, in which according to the invention state changes in the memory contents are caused by specific interruption of an auxiliary function of the semiconductor memory 2. In addition, a second memory region 7 is situated in the semiconductor memory 2, in which the produced state changes of the memory cells of the first memory region 6 are stored as reference state changes for identification of the individual electronic sub-assembly 1.

In the following, the initialization phase of the method according to the invention for tamperproof identification of an individual electronic sub-assembly which is implemented with the help of a firmware implemented on the individual electronic sub-assembly 1 is presented with reference to FIG. 2. The initialization phase is implemented once during operational introduction of an individual electronic sub-assembly.

In the first method step S10 of the method according to the invention for tamperproof identification of an individual electronic sub-assembly, the individual memory cells of the first memory region 6 of the semiconductor memory 2 are written to with a specific pre-established logic memory content, whereas the semiconductor memory 2 is operated in its normal operation—stabilised switched-on supply voltage, cyclic refreshing of the individual memory cells, continuous clocking and requirement-orientated reading from and writing to memory cells.

In the subsequent method step S20, after the memory cells of the first memory region 6 of the semiconductor memory 2 have stored the prescribed bit pattern in a stable manner and the above-mentioned conditions of a stable normal operation of the semiconductor memory 2 prevail in addition, one or more auxiliary functions of the semiconductor memory 2—supply voltage, clock signal, refresh signal—are switched off specifically for a specific duration via the switchable connections 3, 4 and 5.

After the semiconductor memory 2 is again in normal operation after a specific interruption of one or more auxiliary functions of a specific duration, the memory contents of each individual memory cell of the first memory region 6 of the semiconductor memory 2 are read out in method step S30 and are examined with respect to a change relative to the memory contents of the same memory cells before the interruption of one or more auxiliary functions of the semiconductor memory 2. As a result of this analysis, those memory cells of the first memory region 6 which have experienced a state change as a result of the interruption of one or more auxiliary functions of the semiconductor memory 2 are determined.

The determined number of state changes in the memory cells of the first memory region 6 is compared, in method step S40, with a pre-established lower boundary value which characterizes the minimum required number of state changes for the method according to the invention as a result of interruption of an auxiliary function.

If the comparison in method step S40 produces a number of state changes which is lower relative to the lower boundary value, then the state changes determined in method step S30 are discarded as an unusable result and, for renewed determination of state changes in method step S50, the duration of the next interruption of one or more auxiliary functions of the semiconductor memory 2 is increased in order, as a result of an interruption of one or more auxiliary functions of the semiconductor memory 2 according to method step S20, hence to achieve a higher number, corresponding to the statistical character of this physical effect, of state changes in the memory cells of the first memory region 6 of the semiconductor memory 2. For this purpose, following method step S40, the first memory region 6 of the semiconductor memory 2 is written to with the bit pattern which is established in the method step S10 corresponding to the previous passes.

If the determined number of state changes, corresponding to the comparison in method step S40, is greater than the pre-established lower boundary value, the number of state changes determined in method step S30 is compared, in a further method step S60, with a pre-established upper boundary value which characterizes the maximum possible number of state changes for the method according to the invention as a result of interruption of an auxiliary function.

If this second comparison in method step S60 gives the result that the number of state changes determined in method step S30 is greater than the pre-established upper boundary value, then these determined state changes are discarded as an unusable result and, in method step S70, the duration of the interruption of one or more auxiliary functions of the semiconductor memory 2 is reduced for renewed determination of state changes. In this way, in a subsequent repeated interruption of one or more auxiliary functions of the semiconductor memory 2, a lower number of state changes corresponding to the statistical behavior of this physical effect is expected in the memory cells of the first memory region 6. For this purpose, following method step S70, the first memory region 6 of the semiconductor memory 2 is written to with the bit pattern which is established in method step S10 corresponding to the previous passes.

If the second comparison in method step S60 results, in contrast, in a lower number, relative to the upper boundary value, of state changes which are determined in method step S30, then the number of determined state changes is in a meaningful range for the subsequent evaluation of the method according to the invention. In a subsequent method step S80, for all the memory cells of the first memory region 6 for which a state change was logged in method step S30, a counter which is situated in the second memory region 7 of the semiconductor memory 2 for the respective memory cell is incremented respectively by the factor 1.

The method steps S10 to S80 are implemented again if a minimum number of pre-established repetitions of these method steps S10 to S80 has not yet been achieved or if the analysis of the counts associated with all the memory cells of the first memory region 6 of the semiconductor memory 2 reveals that still no significant marked degree of counters with comparatively high counts and at the same time of counters with comparatively low counts is present and hence still no result with a meaningfully minimal statistical scatter which can be used for the method according to the invention.

If however a required number of repetitions of the method steps S10 to S80 has been implemented and if a distribution, which can be used for the method according to the invention, of counts which are associated with the individual memory cells of the first memory region 6 is present, then a sufficient number of repetitions has been implemented according to method step S90. In this case, in the subsequent method S100, the memory cells, the counters of which have comparatively high counts, are determined. These memory cells represent the memory cells with reference state changes which are required for the test phase of the method according to the invention for tamperproof identification of an individual electronic sub-assembly. The memory-characteristic combination of memory cells with a determined reference state change and memory cells without a determined reference state change, which as described above depend upon the concrete production conditions of the individual semiconductor memory 2 and hence have a unique character, represent an identification for the individual semiconductor memory 2 and hence for the individual electronic sub-assembly 1 containing the individual semiconductor memory 2 and are stored in a second memory region 7 of the semiconductor region 2.

Optionally, in addition to the identification which identifies the individual electronic sub-assembly 1 and comprises the reference state change which is present or not present per memory cell of the first memory region 6, a coding of this identification can be implemented in method step S110. A hash function can hereby be used preferably, which transforms the data format of the uncoded identification to a data format of the coded identification with a lower data width and low collision. Finally, in addition a further identifying feature of the individual electronic sub-assembly—for example the serial number of the electronic sub-assembly—can be included in the coding. The coded identification is stored, analogously to the uncoded identification, in the second memory region 7 of the semiconductor memory 24 for the test phase of the method according to the invention for tamperproof identification of an individual electronic sub-assembly.

The test phase of the method according to the invention for tamperproof identification of an individual electronic sub-assembly is presented subsequently with reference to FIG. 3. This test phase is implemented each time that an individual electronic sub-assembly must be identified within the framework of one of the above-mentioned applications.

Analogously to method step S10 of the initialization phase, in method step S200 all the memory cells of the first memory region 6 of the semiconductor memory 2 of the individual electronic sub-assembly 1 to be identified are written to with a pre-established memory content after stabilization of the normal operation of the semiconductor memory 2. In order to create equivalent conditions, the same bit pattern must be used for this purpose as in the initialization phase.

In the subsequent method step S210, likewise analogously to method step S20 of the initialization phase, a specific interruption of one or more auxiliary functions of the memory must be implemented with a specific pre-established duration after stabilization of the stored states of the individual memory cells of the first memory region 6 of the semiconductor memory 2. In order to achieve likewise equivalent effects as in the initialization phase, the same auxiliary functions must be hereby interrupted within the same established duration as in the initialization phase.

Finally in method step S220, as soon as the semiconductor memory 2 is again situated in normal operation, the stored states of all the memory cells of the first memory region 6 of the semiconductor memory 2 are determined and compared with the stored states of the identical memory cells before interruption of one or more auxiliary functions of the semiconductor memory 2 with respect to state changes.

In method step S230, likewise analogously to method step S50, the determined number of state changes in the memory cells of the first memory region 6 is compared with a pre-established upper boundary value.

If the number of state changes determined in method step S220 exceeds the upper boundary value and hence an identification result is present which is unusable for further evaluation, these determined state changes are discarded as a result and, in a subsequent method step S240, the duration of the interruption of one or more auxiliary functions of the semiconductor memory 2 is reduced for a repeated pass of the method steps S200, S210 and S220 in the expectation that, by using the statistical character of the thereby occurring physical effect, the number of state changes in the memory cells of the first memory region 6 is statistically reduced.

However if the number of state changes determined in method step S250 falls below the upper boundary value then, in a second comparison in method step S270, the number of state changes determined in method step S220 is compared with a pre-established lower boundary value.

In the case where the number of state changes determined in method step S220 falls below the lower boundary value and hence an identification result is present which is unusable for further evaluation, these determined state changes are discarded as a result and, in a subsequent method step S260, the duration of the interruption of one or more auxiliary functions of the semiconductor memory 2 is increased for a repeated pass of the method steps S200, S210 and S220 in the expectation that consequently, using the statistical character of the thereby present physical effect, the number of state changes in the memory cells of the first memory region 6 is statistically increased.

If the number of state changes determined in method step S220 is greater than the lower boundary value and hence in a region which is meaningful for further evaluation, then in method step S270 testing takes place as to whether the state changes determined in method step S220 of the test phase correspond at least to a partial quantity of the reference state changes determined in the initialization phase.

If the state changes, determined in method step S220, of the memory cells of the first memory region 6 correspond, only as a percentage which is lower relative to the partial quantity established in method step S270, to the reference state changes of the memory cells of the first memory region 6 which are determined in the initialization phase, then in method step S280 the individual electronic sub-assembly 1 to be identified is classified as not identified.

In the opposite case—the state changes, which are determined in method step S220, of the memory cells of the first memory region 6, as a percentage which is greater relative to the partial quantity established in method step S270, are identical to the reference state changes, which are determined in the initialization phase, of the memory cells of the first memory region 6—the individual electronic sub-assembly 1 to be identified is classified in method step S290 as identified.

Corresponding to method step S110 of the initialization phase, the state changes, which are determined in method step S220, of the memory cells of the first memory region 6 of the semiconductor memory 2 are coded in method step S300 with a coding method which is identical to the initialization phase.

In the subsequent method step S310, a comparison of the coded state changes, which are determined in method step S220, of the memory cells of the first memory region 6 with the reference state changes which are coded in the initialization phase and stored in the second memory region 7 of the semiconductor memory 2 is effected. In the case of a lack of identity between coded state changes and coded reference state changes, in method step S320 the individual electronic sub-assembly 1 to be identified is not identified by means of the coded identification.

However, if in comparison with the method step S310 there is identity between the coded state changes and coded reference state changes, then the individual electronic sub-assembly 1 to be identified is classified in method step S330 as identified also by means of the coded identification.

The invention is not restricted to the represented embodiment. Coding methods other than the hash method are covered in particular by the invention.

1. Individual electronic sub-assembly having a tamperproof identification which is stored in a memory associated with the electronic sub-assembly, said identification of the individual electronic sub-assembly being produced from a memory-characteristic state change of specific memory cells of the memory as a result of a specific interruption of at least one auxiliary function of the memory.

2. Individual electronic sub-assembly having a tamperproof identification according to claim 1, wherein
the memory is a volatile semiconductor memory—DRAM memory.

3. Individual electronic sub-assembly having a tamperproof identification according to claim 2, wherein
the specific interruption of the auxiliary function of the volatile memory is switching-off of a supply voltage, removal of a clock signal, or discontinuation of the refresh cycles of the volatile memory.

4. Method for tamperproof identification of individual electronic sub-assemblies, comprising comparing state changes of specific memory cells of the memory resulting from a specific interruption of at least one auxiliary function of a memory of an individual electronic sub-assembly with respect to identity with pre-determined memory-characteristic reference state changes of specific memory cells of the memory resulting from the specific interruption of the auxiliary function of the memory of the electronic sub-assembly.

5. Method for tamperproof identification of individual electronic sub-assemblies according to claim 4, wherein
the interruption of the auxiliary function of the memory has a specific duration.

6. Method for tamperproof identification of individual electronic sub-assemblies according to claim 4, comprising identifying
the individual electronic sub-assembly if a number of determined state changes of specific memory cells of the memory of the individual electronic sub-assembly does not exceed a specific upper boundary value and corresponds at least partially to the pre-determined memory-characteristic reference state changes.

7. Method for tamperproof identification of individual electronic sub-assemblies according to claim 6, comprising not identifying
the individual electronic sub-assembly if a number of determined state changes of specific memory cells of the memory of the individual electronic sub-assembly exceeds a specific lower boundary value and is smaller than a specific partial quantity of the pre-determined memory-characteristic reference state changes.

8. Method for tamperproof identification of individual electronic sub-assemblies according to claim 6, comprising
in the case of a larger number of determined state changes relative to the upper boundary value, the state changes resulting from a repeated interruption of a longer duration of the auxiliary function of the memory with respect to identity with the pre-determined memory-characteristic reference state changes.

9. Method for tamperproof identification of individual electronic sub-assemblies according to claim 7, comprising
in the case of a smaller number of determined state changes relative to the lower boundary value, again comparing the state changes resulting from a repeated interruption of a shorter duration of the auxiliary function of the memory with respect to identity with the pre-determined memory-characteristic reference state changes.

10. Method for tamperproof identification of individual electronic sub-assemblies according to claim 5, comprising producing
the memory-characteristic reference state changes of specific memory cells of the memory of the individual electronic sub-assembly from the state changes of specific memory cells of the memory of the individual electronic sub-assembly, which respectively occur most frequently and respectively result from repeated specific interruptions of the auxiliary function of the memory.

11. Method for tamperproof identification of individual electronic sub-assemblies according to claim 7, comprising
in the case of repeated specific interruptions of the auxiliary function of the memory, when determining the reference state changes taking into account only those respectively resulting state changes of specific memory cells of the memory, a number of which is within the lower and upper boundary values.

12. Method for tamperproof identification of individual electronic sub-assemblies according to claim 7, comprising
in the case of repeated specific interruptions of the auxiliary function of the memory in order to determine the reference state changes, the duration of the subsequent interruption if a smaller number of state changes of the specific memory cells of the memory relative to the lower boundary value is determined from a preceding interruption.

13. Method for tamperproof identification of individual electronic sub-assemblies according to claim 6, comprising
in the case of repeated specific interruptions of the auxiliary function of the memory in order to determine the reference state changes, reducing the duration of the subsequent interruption if a larger number of state changes of the specific memory cells of the memory relative to the upper boundary value is determined from a preceding interruption.

14. Method for tamperproof identification of individual electronic sub-assemblies according to claim 4, comprising
in order to determine the state changes or reference state changes of specific memory cells of the memory of an individual electronic sub-assembly, resulting from a specific interruption of the auxiliary function of the memory, the pre-allocation respective memory cells respectively with a specific memory state.

15. Method for tamperproof identification of individual electronic sub-assemblies according to claim 14, comprising
after a specific interruption of the auxiliary function of the memory comprising, the arising memory states of specific memory cells of the memory of an individual electronic sub-assembly with the associated pre-allocated memory states, before the interruption of the auxiliary function, with respect to a state change, and storing the respectively identified state changes in the memory as reference state changes.

16. Method for tamperproof identification of individual electronic sub-assemblies according to claim 4, comprising
after repeated specific interruption of the auxiliary function of the memory determining, the memory cells of the memory respectively with identified state changes and incrementing the counts of counters situated in the memory, wherein the counts belong to those memory cells of the memory in which a state change was identified respectively.

17. Method for tamperproof identification of individual electronic sub-assemblies according to claim 16, wherein
those memory cells of the memory have a reference state change, the associated counter of which has a count which is noticeably higher in comparison with the counters which are associated with the other memory cells of the memory.

18. Method for tamperproof identification of individual electronic sub-assemblies according to claim 4, comprising coding and storing
the reference state changes which are determined after at least one specific interruption of the auxiliary function of the memory in the memory as coded reference state changes.

19. Method for tamperproof identification of individual electronic sub-assemblies according to claim 18, comprising effecting
the coding of the reference state change via a hash function.

20. Method for tamperproof identification of individual electronic sub-assemblies according to claim 18, comprising integrating
additional identifying reference features of the individual electronic sub-assembly into the coding of the reference state changes.

21. Method for tamperproof identification of individual electronic sub-assemblies according to claim 18, comprising
when coded reference state changes are present, after identification of the electronic sub-assembly with the reference state changes, coding the state changes, which result from the specific interruption of the auxiliary function of the memory of the individual electronic sub-assembly and are determined with the reference state changes for the identification, and comparing said state changes with respect to identity with the coded reference state changes.

22. Method for tamperproof identification of individual electronic sub-assemblies according to claim 20, comprising
during coding of the reference state changes with additional identifying reference features, after identification of the electronic sub-assembly with the reference state changes, coding the state changes, which result from the specific interruption of the auxiliary function of the memory of the individual electronic sub-assembly and are determined with the reference state changes for the identification, together with the additional identifying features of the electronic sub-assembly and comparing said state changes with respect to identity with the coded reference state changes.
